(19) United States
(12) Patent Application Publication
(10) Pub. No.: US 2025/0179649 A1
(43) Pub. Date: Jun. 5, 2025

(54) BRIDGED IMIDAZOLINES AS ENVIRONMENTALLY FRIENDLY CORROSION INHIBITORS

(71) Applicant: ChampionX LLC, Sugar Land, TX (US)

(72) Inventors: Izabela Anita Owsik, College Station, TX (US); Christopher Steven Popeney, Sugar Land, TX (US)

(21) Appl. No.: 18/966,506

(22) Filed: Dec. 3, 2024

Related U.S. Application Data
(60) Provisional application No. 63/606,346, filed on Dec. 5, 2023.

(51) Int. Cl. C23F 11/173; C09K 8/54

(52) U.S. Cl. CPC C23F 11/173; C09K 8/54

(57) ABSTRACT

Environmentally-friendly corrosion-inhibiting compositions and methods of use thereof for corrosion inhibition of metal surfaces used in oil and gas operations are disclosed. Corrosion-inhibiting compositions include a mono (meth)acrylated and/or bridged imidazoline corrosion inhibitor, namely a mono (meth)acrylated and/or bridged imidazoline corrosion inhibitor with a molecular weight of at least about 700 Da and therefore does not bioaccumulate according to CEFAS regulations and provides suitable biodegradability.

### CROSS REFERENCE TO RELATED APPLICATIONS

This application claims priority under 35 U.S.C. § 119 to provisional patent application U.S. Ser. No. 63/606,346, filed Dec. 5, 2023. The provisional patent application is herein incorporated by reference in its entirety.

### TECHNICAL FIELD

The present disclosure relates generally to environmentally-friendly corrosion-inhibiting compositions and methods of use thereof for corrosion inhibition of metal surfaces used in oil and gas operations. Corrosion-inhibiting compositions include a mono (meth)acrylated and/or bridged imidazoline corrosion inhibitor, namely a bridged imidazoline corrosion inhibitor with a molecular weight of at least about 700 Da that averts bioaccumulation and provides suitable biodegradability.

### BACKGROUND

Corrosion remains a significant challenge in the oil and gas industry and is most often caused by salts and/or other dissolved solids, liquids, or gases that cause, accelerate, or promote corrosion of surfaces such as metal surfaces. Examples of corrodents include water electrolytes, such as sodium chloride, calcium chloride, oxygen, hydrogen sulfide, carbon dioxide, sulfur dioxide, and the like. Corrosion negatively impacts metal surfaces such as metal pipelines, tanks, and/or other metal equipment or devices used before, during, or after injection or production.

A majority of operators in the oil and gas extraction and processing industry employ corrosion inhibitors to reduce internal corrosion in metal surfaces which are contacted by aqueous liquids containing corrodents. Corrodents are found in injectates, produced water, waste water from a manufacturing process, connate (native water present in subterranean formations along with the hydrocarbon), and hydrocarbon liquids and solids. Corrosion inhibitors are added to the liquids which come into contact with metal surfaces where they act to prevent, retard, delay, reverse, and/or otherwise inhibit the corrosion of metal surfaces such as carbon-steel metal surfaces. Corrosion inhibitors are beneficial in that they extend the lifespan of metal surfaces, as well as permit the use of carbon steel components rather than more expensive metals, such as nickel, cobalt, and chromium alloys or other materials more expensive than carbon steel and/or which inherently entail other disadvantages in suitability for the purpose of liquid or gas containment.

There is an ongoing goal to develop more environmentally friendly corrosion inhibitors which include jurisdictional requirements related to toxicity and biodegradability thresholds. Since corrosion inhibitors are surface active compounds, they are expected to bioaccumulate. Therefore, there are required biodegradability thresholds for corrosion inhibitors that are expected to bioaccumulate based on molecular weights of the active species. Therefore, it is an object of the disclosure to provide corrosion inhibitors for corrosion-inhibiting compositions that meet toxicity, molecular weight, and biodegradability thresholds to provide environmentally friendly corrosion inhibitors according to jurisdictional requirements, namely Centre for Environment, Fisheries and Aquaculture Science (CEFAS).

It is therefore an object of this disclosure to provide corrosion-inhibiting compositions and methods for corrosion inhibition of metal surfaces that improve on existing corrosion inhibitors bioaccumulation and biodegradability through providing mono (meth)acrylated and/or bridged imidazoline corrosion inhibitors.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide compositions and methods for inhibiting corrosion in oil and gas operations.

According to some aspects of the present disclosure, corrosion-inhibiting compositions comprise a mono (meth)acrylated (I or II) and/or bridged (III) imidazoline corrosion inhibitor with the following general structures, respectively:

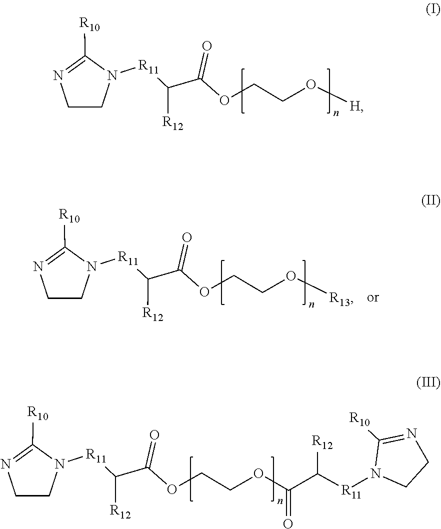

wherein: R¹⁰ is a C₁-C₂₀ alkyl, alkenyl, hydroxyalkyl or hydroxyalkenyl group; R¹¹ is a C₁-C₁₀ alkyl amine; R¹² is hydrogen or CH₃; R¹³ is hydrogen, acrylate, methylacrylate, C₁-C₁₈ alkyl group, or C₁-C₆ cycloalkyl group; n is 1 to 22; and wherein the corrosion inhibitor has a molecular weight≥700 Da and, therefore, does not bioaccumulate according to CEFAS regulations.

According to additional aspects of the present disclosure, methods of making the mono (meth)acrylated and/or bridged imidazoline corrosion inhibitor comprising: synthesizing an imidazoline reaction product of a fatty acid, polyamine, and (meth)acrylate in a sequential method; wherein the sequential method comprises first reacting the fatty acid and polyamine to produce the imidazoline reaction product, and thereafter reacting the (meth)acrylate with the imidazoline reaction product via Michael addition to form the mono (meth)acrylated (I or II) and/or bridged (III) imidazoline corrosion inhibitors having the structures as follow:

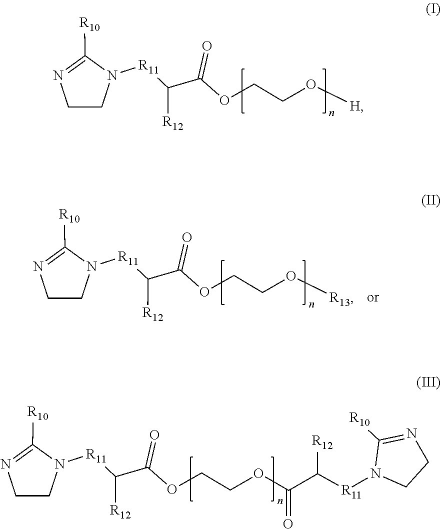

wherein: R¹⁰ is a C₁-C₂₀ alkyl, alkenyl, hydroxyalkyl or hydroxyalkenyl group; R¹¹ is a C₁-C₁₀ alkyl amine; R¹² is hydrogen or CH₃; R¹³ is hydrogen, acrylate, methylacrylate, C₁-C₁₈ alkyl group, or C₁-C₆ cycloalkyl group; n is 1 to 22; and wherein the corrosion inhibitor has a molecular weight≥700 Da and, therefore, does not bioaccumulate according to CEFAS regulations. In further aspects the sequential method is a single one-pot process and does not separate the imidazoline reaction product before reacting with the acrylate to form the bridged imidazoline corrosion inhibitor.

According to additional aspects of the present disclosure, methods of controlling corrosion on a surface comprising: contacting a corrosive inhibiting effective amount of the corrosion inhibition composition as described herein, or the mono (meth)acrylated and/or bridged imidazoline corrosion inhibitor produced by the methods as described herein, with a surface comprising metal in an oil-and-gas system, wherein the contacting is added in a batch or continuous application, and reducing corrosion on the surface.

According to still further aspects of the present disclosure, treated metal containments comprise: a metal containment comprising a metal surface; and a barrier or film substantially coating the metal surface with a corrosive inhibiting effective amount of the corrosion-inhibiting compositions described herein or the mono (meth)acrylated and/or bridged imidazoline corrosion inhibitor produced by the methods described herein.

According to additional aspects of the present disclosure, methods of reducing, inhibiting or preventing both corrosion and metal wear of a metal surface comprise contacting a metal surface with a corrosion-inhibiting composition as described herein to reduce, inhibit or prevent both corrosion and metal wear of the metal surface, wherein the metal surface is used in recovery, transportation, refining or storage of a hydrocarbon fluid.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. This applies regardless of the breadth of the range.

As used herein, the term “and/of”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, “consisting of” and “consisting essentially of”, the embodiments or elements presented herein, whether explicitly set forth or not.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, molecular size, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyls can include straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Commonly used alkyl groups include, but are not limited to, methyl, ethyl, n-propyl, isopropyl, n-butyl, iso-butyl, secondary-butyl, and tertiary-butyl.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups. In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “containment” or “metal containment” includes any metal surface or portion thereof that is in contact with a gas or liquid phase from an oil-field system containing corrodents. In embodiments the containment is in fluid communication with one or more devices or apparatuses, including other containments. In embodiments the containment is a pipe. In embodiments the containment is a tank. In embodiments, the metal is steel. In embodiments, the steel is carbon steel. In embodiments, the carbon steel is stainless steel.

As used herein, the term “corrodent” refers to one or more salts and/or other dissolved solids, liquids, or gases that cause, accelerate, or promote corrosion of metals. Exemplary corrodents common in oil and gas applications include, water electrolytes, such as sodium chloride, calcium chloride, oxygen, hydrogen sulfide, carbon dioxide, sulfur dioxide, and the like.

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

As used herein, the term “fluid source” means any fluid used in oil or gas well production operations that contain one or more corrodents.

The term “generally” encompasses both “about” and “substantially.”

The term “inhibiting” as referred to herein includes inhibiting, preventing, retarding, mitigating, reducing, controlling and/or delaying corrosion on a surface or within a system, namely an oil-field system.

As used herein, the term “injectate” means water plus any solids or liquids dispersed therein that is injected into a subterranean formation for the purpose of inducing hydrocarbon recovery therefrom. Injectates optionally include salts, polymers, surfactants, scale inhibitors, stabilizers, metal chelating agents, corrosion inhibitors, paraffin inhibitors, and other additives as determined by the operator in a subterranean hydrocarbon recovery process.

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein, the term “produced water” means water that flows back from a subterranean reservoir and is collected during a hydrocarbon recovery process including, but not limited to hydraulic fracturing and tertiary oil recovery. Produced water includes residual hydrocarbon products entrained therein and one or more of injectate, connate (native water present in the subterranean formation along with the hydrocarbon), brackish water, and sea water. Produced water ranges in temperature from about −30° C. to about 200° C., depending on the subterranean reservoir and the terranean environment and infrastructure proximal to the subterranean reservoir.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Corrosion-Inhibiting Compositions

According to embodiments, the corrosion-inhibiting compositions include from about 0.1 wt-% to about 90 wt-% of a mono (meth)acrylated and/or bridged imidazoline corrosion inhibitor. In embodiments the corrosion-inhibiting compositions can further comprise a solvent and/or at least one additional functional ingredient.

In embodiments the corrosion-inhibiting compositions are described in weight percentages of the compositions. While the components may have a percent active of 100%, it is noted that the percent actives of the components is not defined, but rather, total weight percentage of the raw materials (i.e. active concentration plus inert ingredients) are disclosed. In an exemplary embodiment the mono (meth)acrylated and/or bridged imidazoline corrosion inhibitor comprises from about 0.1 wt-% to about 90 wt-% of the composition, and the solvent(s) and/or additional functional ingredient(s) comprises from about 10 wt-% to about 99.9 wt-% of the composition.

### Mono and Bridged Imidazoline Corrosion Inhibitors

The corrosion-inhibiting composition comprise a mono (meth)acrylated and/or bridged imidazoline corrosion inhibitor. The term “corrosion inhibitor (or referred to as CI)” refers to a compound or mixture of compounds that prevents, retards, mitigates, reduces, controls and/or delays corrosion.

The mono (meth)acrylated imidazoline corrosion inhibitor has the following general structures (I, II):

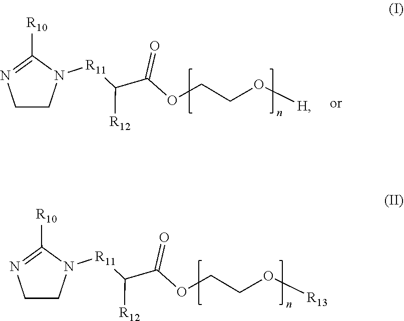

wherein: R₁₀ is a C1-C20 alkyl, alkenyl, hydroxyalkyl or hydroxyalkenyl group; R₁₁ is a C1-C10 alkyl amine; R₁₂ is H or CH₃; R₁₃ is hydrogen, acrylate, methylacrylate, C1-C18 alkyl group, or C1-C6 cycloalkyl group; n is 1 to 22; and wherein the corrosion inhibitor has a molecular weight≥700 Da and, therefore, does not bioaccumulate according to CEFAS regulations.

In an exemplary embodiment the mono (meth)acrylated imidazoline corrosion inhibitor has the following general structure:

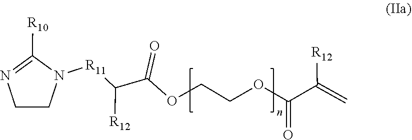

wherein R¹⁰ is a C₁-C₂₀ alkyl, alkenyl, hydroxyalkyl or hydroxyalkenyl group, R¹¹ is a C₁-C₁₀ alkyl amine, R¹² is hydrogen or CH₃; n is 1 to 22, and wherein the corrosion inhibitor has a molecular weight≥700 Da and, therefore, does not bioaccumulate according to CEFAS regulations.

In embodiments the mono (meth)acrylated imidazoline corrosion inhibitor has the same general structure wherein: R¹⁰ is a C₁-C₂₀ alkyl, alkenyl, hydroxyalkyl or hydroxyalkenyl group, that is free of aromatic groups, including for example terpenes and napthenes, including for example cyclopentyl groups, cyclohexyl groups, and other cyclic aliphatic hydrocarbons; R¹¹ is a C₁-C₁₀ alkyl amine or triamine; and n is 2 to 22, or 10 to 22, or 10 to 18.

The bridged imidazoline corrosion inhibitor has the following general structure (III):

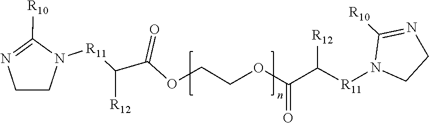

wherein R¹⁰ is a C₁-C₂₀ alkyl, alkenyl, hydroxyalkyl or hydroxyalkenyl group; R¹¹ is a C₁-C₁₀ alkyl amine; R¹² is hydrogen or CH₃; n is 1 to 22; and wherein the corrosion inhibitor has a molecular weight≥700 Da and, therefore, does not bioaccumulate according to CEFAS regulations.

In embodiments the bridged imidazoline corrosion inhibitor has the same general structure wherein: R¹⁰ is a C₁-C₂₀ alkyl, alkenyl, hydroxyalkyl or hydroxyalkenyl group, that is free of aromatic groups, including for example terpenes and naphthenes, including for example cyclopentyl groups, cyclohexyl groups, and other cyclic aliphatic hydrocarbons; R¹¹ is a C₁-C₁₀ triamine; and n is 2 to 22, or 10 to 22, or 10 to 18.

In embodiments the mono (meth)acrylated and/or bridged imidazoline corrosion inhibitor can have the following general structure, respectively:

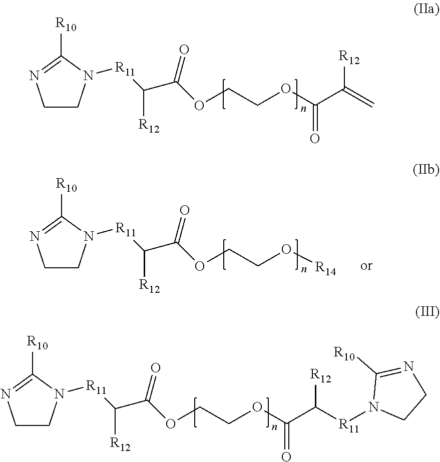

wherein R¹⁰ is a C₁-C₂₀ alkyl, alkenyl, hydroxyalkyl or hydroxyalkenyl group, R¹¹ is a C₁-C₁₀ alkyl amine, and wherein R¹² is hydrogen or CH₃; R¹⁴ is hydrogen, C1-C18 alkyl group, or C1-C6 cycloalkyl group; and n is 4.

In embodiments the mono (meth)acrylated and/or bridged imidazoline corrosion inhibitor can have the following general structure, respectively:

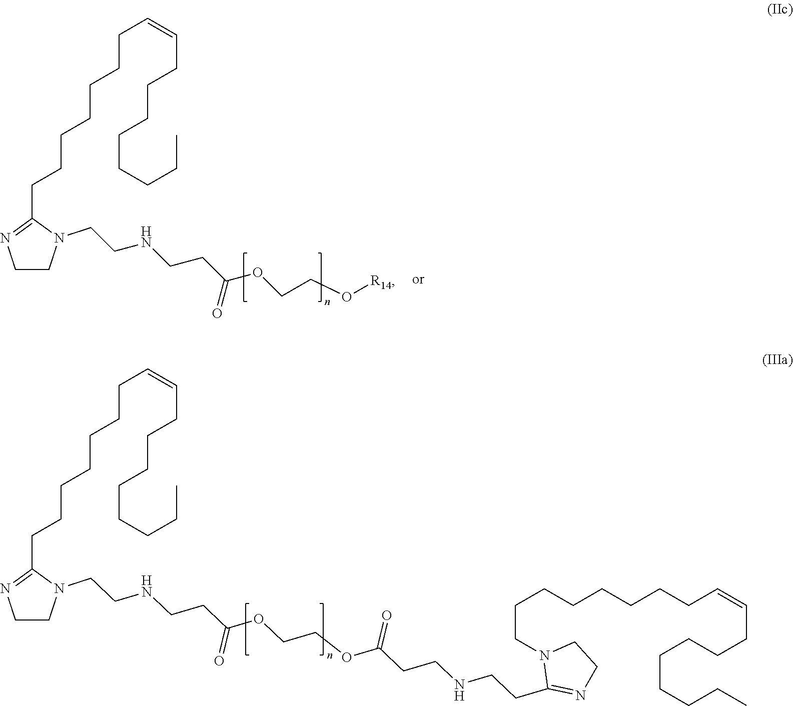

wherein R¹⁴ is hydrogen, C1-C18 alkyl group, or C1-C6 cycloalkyl group, and n is 1 to 22, 2 to 22, or 10 to 22, or 10 to 18.

In still further embodiments the mono (meth)acrylated and/or bridged imidazoline corrosion inhibitor can have the structures (IIc) or (IIIa) wherein R¹⁴ is hydrogen, C1-C6 alkyl group, or C1-C6 cycloalkyl group; and n is 4. In some embodiments, the corrosion inhibitors are included in the composition at an amount of at least about 0.1 wt-% to about 90 wt-%, about 1 wt-% to about 90 wt-%, about 1 wt-% to about 50 wt-%, about 5 wt-% to about 50 wt-%, or about 10 wt-% to about 50 wt-%. In addition, without being limited according to the disclosure, all ranges recited are inclusive of the numbers defining the range and include each integer within the defined range.

The mono (meth)acrylated and/or bridged imidazoline corrosion inhibitors are made by synthesizing an imidazoline reaction product of a fatty acid, polyamine, and acrylate. The methods include a sequential synthesis of first reacting the fatty acid and polyamine to produce the imidazoline reaction product, and thereafter reacting the acrylate with the imidazoline reaction product via Michael addition to form the mono (meth)acrylated and/or bridged imidazoline corrosion inhibitor having the structure

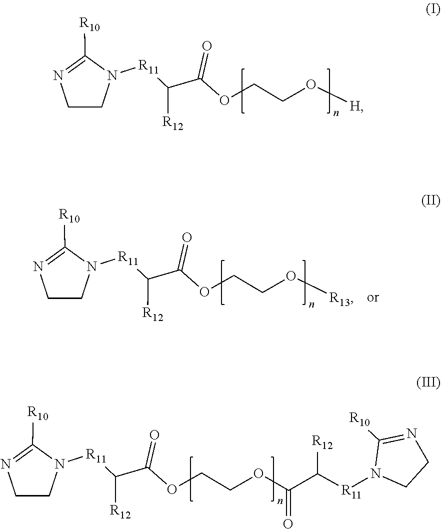

wherein: R₁₀ is a C₁-C₂₀ alkyl, alkenyl, hydroxyalkyl or hydroxyalkenyl group; R₁₁ is a C1-C10 alkyl amine; R₁₂ is H or CH₃; R¹³ is hydrogen, acrylate, methylacrylate, C1-C18 alkyl group, or C1-C6 cycloalkyl group; n is 1 to 22; and wherein the corrosion inhibitor has a molecular weight≥700 Da and, therefore, does not bioaccumulate according to CEFAS regulations. Preferably in an embodiment the sequential method is a single one-pot process and does not separate the imidazoline reaction product before reacting with the acrylate to form the bridged imidazoline corrosion inhibitor.

The methods first react a fatty acid and polyamine to produce the imidazoline reaction product. The fatty acid is preferably a tall oil fatty acid (TOFA) or a fatty acid from a fatty oil. Exemplary TOFA comprises oleic acid, linoleic acid, abietic acid, neoabietic acid, palustric acid, pimaric acid, dehydroabietic acid, palmitic acid, stearic acid, ricinoleic acid, myristoleic acid, sapienic acid, vaccenic acid, palmitoleic acid, 5,9,12-octadecatrienoic acid, linolenic acid, 5,11,14-eicosatrenoic acid, cis,cis-5,9-octadecadienoic acid, eicosadienoic acid, elaidic acid, cis-11-octadecanoic acid, or a combination thereof. Exemplary fatty oils include castor oil, coconut oil, corn oil, soy bean oil, rapeseed oil, linseed oil, palm oil, safflower oil, peanut oil, canola oil, cotton seed oil, olive oil, sunflower oil, etc. or a combination thereof.

Exemplary polyamines include diethylene triamine (DETA), aminoethylethanolamine (AEEA), triethylene tetraamine (TETA), tetraethylenepentamine (TEPA), pentaethylene hexamine (PEHA), hexaethylene heptamine (HEHA) and N-alkyl diethylene triamines. Additional polyamines include C1-C10 alkyl polyamines, such as N-alkyl diethylene triamines including N-alkyl diethylene triamine. In preferred embodiments the polyamine is at least a triamine.

Exemplary acrylates for reacting with the imidazoline reaction product via Michael addition include, for example a monoacrylate or diacrylate. Exemplary mono- and diacrylates include for example, poly(ethylene glycol) diacrylate (PEGDA), tetra ethylene glycol diacrylate (TEGDA), hydroxyl ethyl acrylate, hydroxyethyl acrylate and PEG acrylate. Exemplary diacrylates PEGDA and TEGDA have the following respective structures:

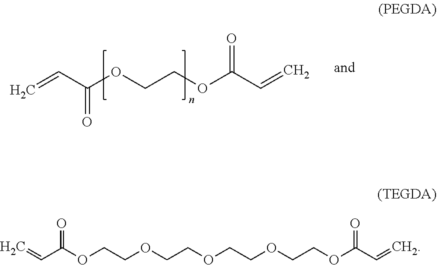

In embodiments, the molar ratio of the amine group on the imidazoline to the carbon double bonds on the acrylate is from about 2:1 to about 1:1, or preferably from about 1.5:1 to about 1:1.

In embodiments for producing mono (meth)acrylated imidazoline corrosion inhibitors, the molar ratio of the amine group on the imidazoline to the carbon double bonds on the acrylate is about 1:1.

In embodiments, the reaction temperature is below about 150° F. to prevent side reactions and optionally comprises a solvent. An exemplary solvent for the synthesis of the bridged imidazoline corrosion inhibitor is a glycol, namely ethylene glycols to lower the viscosity of the reaction mixture.

### Solvent

The corrosion-inhibiting compositions can include a solvent. Exemplary solvents include organic solvents, aromatic solvents, and/or water.

Exemplary organic solvents include alcohols, hydrocarbons, ketones, ethers, alkylene glycols, glycol ethers, amides, nitriles, sulfoxides, esters, or a combination thereof. Examples of suitable organic solvents include, but are not limited to, methanol, ethanol, propanol, isopropanol, butanol, 2-ethylhexanol, hexanol, octanol, decanol, 2-butoxyethanol, glycols and derivatives (ethylene glycol, methylene glycol, 1,2-propylene glycol, 1,3-propylene glycol, diethyleneglycol monomethyl ether, ethylene glycol monobutyl ether, ethylene glycol dibutyl ether, etc.), pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof. In preferred embodiments a solvent comprises isopropanol, ethylene glycol, methanol, and/or water.

Exemplary additional solvents include aromatic solvents including aromatic hydrocarbons such as toluene, xylene, heavy aromatic naphtha, or a combination thereof. Environmentally friendly aromatic solvents can include limonene. Preferably, the aromatic solvent comprises heavy aromatic naphtha or xylene. In any of the embodiments described the aromatic solvent(s) is preferably combined with water.

In some embodiments, the solvent is included in the composition at an amount of at least about 10 wt-% to about 99.9 wt-%, about 10 wt-% to about 99 wt-%, about 20 wt-% to about 99 wt-%, about 40 wt-% to about 99 wt-%, about 50 wt-% to about 99 wt-%, about 50 wt-% to about 90 wt-%, about 50 wt-% to about 85 wt-%, about 50 wt-% to about 80 wt-%, or about 50 wt-% to about 75 wt-%. In addition, without being limited according to the disclosure, all ranges recited are inclusive of the numbers defining the range and include each integer within the defined range.

### Additional Functional Ingredients

The corrosion-inhibiting compositions can further be combined with various additional functional components suitable for uses disclosed herein. In some embodiments, the compositions including the mono (meth)acrylated and/or bridged imidazoline corrosion inhibitor and solvent make up a large amount, or even substantially all of the total weight of the compositions. For example, in some embodiments few or no additional functional ingredients are disposed therein. In some embodiments, the composition comprises, consists essentially of, or consists of the mono (meth)acrylated and/or bridged imidazoline corrosion inhibitor and solvent.

In some embodiments the compositions and methods of using the compositions do not include corrosion inhibitors having a molecular weight<700 Da or those that bioaccumulate to present environmental concerns.

In other embodiments, additional functional ingredients may be included in the compositions. The functional ingredients provide desired properties and functionalities to the compositions. For the purpose of this application, the term “functional ingredient” includes a material that when dispersed or dissolved in the use and/or concentrate compositions described herein provides a beneficial property in a particular use.

In some embodiments, the compositions may include additional corrosion inhibitors, surfactants, corrosion inhibitor intensifiers (i.e. synergists), surfactants, polymers, pH modifiers, scale inhibitors, metal complexing agents (i.e. chelants), emulsifiers, water clarifiers, demulsifiers, friction reducers, drag reducing agents, flow improvers, viscosity reducers, sulfur compounds, the like, or combinations thereof.

In further embodiments, the composition may include at least one additional component selected from the group consisting of synergist, additional corrosion inhibitor, surfactant, polymer, pH modifier, scale inhibitor, metal complexing agent, emulsifier, water clarifier, dispersant, emulsion breaker, and combinations thereof.

Exemplary types of the various additional functional ingredients is included in U.S. Pat. No. 11,242,480, which is incorporated by reference in its disclosure of the various listings of additional functional ingredients.

According to embodiments of the disclosure, the various additional functional ingredients may be provided in a composition in the amount from about 0 wt-% and about 40 wt-%, from about 0 wt-% and about 30 wt-%, from about 0 wt-% and about 20 wt-%, from about 0.01 wt-% and about 40 wt-%, from about 0.1 wt-% and about 40 wt-%, from about 0.1 wt-% and about 30 wt-%, from about 0.1 wt-% and about 20 wt-%, or from about 1 wt-% and about 20 wt-%, from about 0.1 wt-% and about 10 wt-%, or from about 1 wt-% and about 10 wt-%. In addition, without being limited according to the disclosure, all ranges recited are inclusive of the numbers defining the range and include each integer within the defined range. Additional examples of additional functional ingredients are listed herein as exemplary wt-% ranges based on the total weight of the compositions, in addition these weight percentage ranges.

The compositions can optionally include corrosion inhibitor intensifiers (i.e. synergists), also referred to as an additive that enhances the performance of corrosion inhibition. Suitable intensifiers may include, but are not limited to, carboxylic acid compounds having 1 to 12 carbon atoms or an ester (including protected carboxylic acid derivatives) or salt thereof, quaternary ammonium compounds, thiol chemistries and others when used in combination with a corrosion inhibitor.

The compositions can optionally include additional corrosion inhibitors. An exemplary additional corrosion inhibitor includes for example carboxylic acids. Carboxylic acids include organic acids having carboxyl group attached to an R-group (R—COOH). In some embodiments, the carboxylic acid is a fatty acid, such as monomeric or oligomeric fatty acid. Exemplary monomeric or oligomeric fatty acids can include saturated and unsaturated fatty acids as well as dimer, trimer and oligomer products obtained by polymerizing one or more of such fatty acids. Additional optional corrosion inhibitors include alkanolamines or salts thereof. Exemplary alkanolamines or salts thereof can include for example, fatty acid alkanolamines, fatty acid ethanolamines, fatty acid diethanolamines or triethanolamines, such as dicarboxylic acid diethanolamines, and salts thereof.

The compositions can optionally include a surfactant. Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates. Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters. Also included are betaines and sultanes, amphoteric surfactants such as alkyl amphoacetates and amphodiacetates, alkyl amphopropionates and amphodipropionates, and alkyliminodipropionate.

The compositions can optionally include a pH modifiers. Suitable pH control additives include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide.

The compositions can optionally include a demulsifier. An exemplary demulsifier comprises an oxyalkylate polymer, such as a polyalkylene glycol. The demulsifier can be included in the compositions from about 0.5 to about 5 wt-% of the composition, based on total weight of the composition.

The compositions can optionally include a dispersant. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersion agents include lignin, or derivatives of lignin such as lignosulfonate and naphthalene sulfonic acid and derivatives. The dispersant can be included in the compositions from about 0.1 to about 10 wt-% of the composition, based on total weight of the composition.

### Methods of Use

The mono (meth)acrylated and/or bridged imidazoline corrosion inhibitors or the corrosion-inhibiting compositions are provided to a system in need of effective corrosion control in the presence of corrodents. The methods of using the mono (meth)acrylated and/or bridged imidazoline corrosion inhibitors or the corrosion-inhibiting compositions provide environmentally-friendly solutions for corrosion inhibition performance and persistency, thereby beneficially increasing the lifespan of the corrosion-inhibiting composition. In some embodiments the presence of a film on a treated surface can beneficially provide lubrication and improve wear and friction with the addition of the film to reduce the wear and friction between moving surfaces, e.g. case tubing and casing, in contact with each other. In other embodiments the corrosion-inhibiting compositions can treat a water system.

The mono (meth)acrylated and/or bridged imidazoline corrosion inhibitors or the corrosion-inhibiting compositions can be provided in a single composition to a system. In referring to compositions, the scope of the methods of using disclosure also includes combining more than one input (i.e. composition) for the treatment of the system in need of corrosion inhibition. In preferred embodiments a single composition provides the mono (meth)acrylated and/or bridged imidazoline corrosion inhibitors or the corrosion-inhibiting compositions.

The methods apply the compositions to a fluid or to a surface to prevent, reduce or mitigate corrosion. The mils penetration per year or milli-inch (one thousandth of an inch) (mpy) is used as an estimated general corrosion rate as it refers to the metal thickness lost in the corrosion process per year. 1 mm y⁻¹ equates to about 40 mpy. The MPY is calculated from the following equation:

$$MPY = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, ρ is the density of the coupon in g/cm², A is the surface area of the coupon in cm², and t is the exposure time in hours. In an embodiment, the corrosion inhibiting compositions provide a reduction in corrosion measured by a milli-inches per year (mpy).

The methods may be applied to fluid systems or onto a surface, such as a containment in contact with fluid systems (also can be referred to as a water source comprising one or more corrodents), including those fluid systems moving through conduits, pipelines, tubulars, transfer lines, valves, and other places or equipment where hydrocarbon fluids are subject to corrosion. In embodiments, the surface can be a containment used in the production, transportation, storage and/or separation of crude oil, natural gas or a biofuel process, downstream chemical, water treatment, geothermal, and other fields.

In some embodiments, a treated metal containment can include the metal containment and a barrier or film substantially coating the metal surface with a corrosive inhibiting effective amount of the compositions or the mono (meth)acrylated and/or bridged imidazoline corrosion inhibitors described herein. In embodiments, the corrosive inhibiting effective amount of the mono (meth)acrylated and/or bridged imidazoline corrosion inhibitor is from about 1 ppm to about 5,000 ppm, or from about 20 ppm to about 1,000 ppm, based on the total volume of the containment.

In embodiments a water source or the fluid system can include an industrial water source, such as a produced water. In embodiments, the water source is a wastewater from an industrial process. The water source comprises one or more corrodents. In some embodiments, the water source comprises water and one or more corrodents, wherein the one or more corrodents comprises, consists essentially of, or consists of metal cations, metal complexes such as aqueous metal cations, metal chelates and/or organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, hydrogen sulfite ions, carbonic acid, hydrochloric acid, nitric acid, sulfuric acid, nitrous acid, sulfurous acid, peroxy acids, phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, polysaccharide, or combinations thereof.

In some embodiments, the one or more corrodents comprises, consists of, or consists essentially of insoluble particulates such as metal oxides, sands, clays, silicon dioxide, titanium dioxide, muds, and other insoluble inorganic and/or organic particulates, which in some embodiments act as abrasives when entrained in a water flow contacting a metal.

In embodiments, a metal surface is in contact with the water source, such as a carbon steel metal surface. In embodiments the carbon steel is stainless steel. In embodiments, the water source is a continuously flowing water source, such as produced water flowing from a subterranean reservoir and into or through a pipe or tank, or wastewater isolated from a continuous manufacturing process flowing into a wastewater treatment apparatus. In other embodiments, the water source is a batch, or plug, substantially disposed in a batchwise or static state within the metal containment.

The mono (meth)acrylated and/or bridged imidazoline corrosion inhibitors or the compositions can be applied to a fluid system at various pH ranges, such as between about 2 to about 10, and temperatures, such as from about OC to about 250° C., as well as various levels of water cut and/or various levels of salinity. The mono (meth)acrylated and/or bridged imidazoline corrosion inhibitors or the compositions can also be applied to a fluid system at various water cuts and salinity.

In embodiments, the fluid system comprises a hydrocarbon fluid, produced water, waste water from a manufacturing process, or combination thereof. As referred to herein, hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. In many embodiments, hydrocarbon fluids comprise refined hydrocarbon product.

In embodiments the fluid system is contained in an oil or gas pipeline or refinery, including both offshore wells and on-shore wells. In embodiments the surface treated with the mono (meth)acrylated and/or bridged imidazoline corrosion inhibitors or the corrosion-inhibiting compositions are metal surfaces in contact with fluid systems moving there through, including for example, conduits, pipelines, tubules, transfer lines, valves, and other places or equipment where hydrocarbon fluids are subject to corrosion. In an embodiment, the metal surface is used in recovery of a hydrocarbon fluid is an offshore well or an onshore well. In an embodiment, the metal surface is used in recovery of a hydrocarbon fluid and is a downhole pumping rod.

A fluid to which the mono (meth)acrylated and/or bridged imidazoline corrosion inhibitors or the compositions can be introduced can be a liquid hydrocarbon. The liquid hydrocarbon can be any type of liquid hydrocarbon. The fluid can be a refined hydrocarbon product.

The fluid can be contained in and/or exposed to many different types of apparatuses. In embodiments, the fluid is contained in a containment, such as an oil and gas pipeline. Additionally, the fluid can be contained in refineries, such as surfaces used in the recovery, transportation, refining and/or storage of hydrocarbon fluids or gases. Exemplary surfaces can include separation vessels, dehydration units, gas lines, oil and/or gas pipelines, or other part of an oil and/or gas refinery. Similarly, the fluid can be contained in and/or exposed to an apparatus used in oil extraction and/or production, such as a wellhead. The apparatus can be part of a coal-fired power plant. The apparatus can be a cargo vessel, a storage vessel, a holding tank, or a pipeline connecting the tanks, vessels, or processing units.

The system to be treated has at least one surface susceptible to corrosion, namely the surface comprises a metal surface subject to corrosion. In embodiments the surfaces can include a variety of metal surfaces that are subject to corrosion. The metals can comprise a component selected from the group consisting of mild steel, galvanized steel, carbon steel, aluminum, aluminum alloys, copper, copper nickel alloys, copper zinc alloys, brass, chrome steels, ferritic alloy steels, austenitic stainless steels, precipitation-hardened stainless steels, high nickel content steels, and any combination thereof.

The mono (meth)acrylated and/or bridged imidazoline corrosion inhibitors or the compositions can be applied by any appropriate method for ensuring dispersal through the fluid or onto a surface, including for example injecting, pumping, pouring, spraying, dripping, or otherwise adding. The mono (meth)acrylated and/or bridged imidazoline corrosion inhibitors or the compositions can be applied to a fluid using various well-known methods and they can be applied at numerous different locations throughout a given system. For example, the mono (meth)acrylated and/or bridged imidazoline corrosion inhibitors or the compositions can be injected using mechanical equipment such as chemical injection pumps, piping tees, injection fittings, atomizers, quills, and the like. The mono (meth)acrylated and/or bridged imidazoline corrosion inhibitors or the compositions can be pumped into an oil and/or gas pipeline using an umbilical line, including capillary string injection systems. U.S. Pat. No. 7,311,144 provides a description of an apparatus and methods relating to capillary injection, the disclosure of which is incorporated into the present application in its entirety.

The method comprises adding a corrosion inhibiting effective amount of the mono (meth)acrylated and/or bridged imidazoline corrosion inhibitors or the composition to the fluid system or onto a surface as a batch dosing to provide a film-like coating on a treated surface, such as a containment. Batch dosing is intended to substantially or preferably fully coat the surface, such as a containment. In embodiments the mono (meth)acrylated and/or bridged imidazoline corrosion inhibitors or the composition is applied as a direct batch application to fully coat the metal surface at a desired concentration, such as from about 1 ppm to about 1,000,000 ppm, from about 1 ppm to about 5,000 ppm, or from about 1 ppm to about 1,000 ppm based on the total volume of the fluid system or the system to be treated.

The dosage amounts of the mono (meth)acrylated and/or bridged imidazoline corrosion inhibitors or the compositions described herein to be added to the fluid system or onto a surface within an oil-and-gas system, can be tailored by one skilled in the art based on factors for each fluid system in need of treatment, including, for example, content of fluid, volume of the fluid, surface area of the system, CO₂ content, temperatures, pH, and CO₂ content. In embodiments, an effective amount of the mono (meth)acrylated and/or bridged imidazoline corrosion inhibitors or the corrosion-inhibiting composition is from about 1 ppm to about 1,000,000 ppm, about 1 ppm to about 5,000 ppm, or from about 1 ppm to about 5,000 ppm based on the total volume of the system (i.e. the volume of the fluid treated or the volume of the system to be treated according to the methods described herein).

In embodiments where the mono (meth)acrylated and/or bridged imidazoline corrosion inhibitors or the composition is added to the fluid system in a batch dosing in-line or offline. In embodiments, offline dosing provides a slug dosing suitable to coat the surfaces (e.g. containment) to provide barrier to the corrodents when the system is back in-line. The embodiments of batch dosing can be done when with or without fluid in the system. In embodiments, batch treatments can use up to 100% of the corrosion-inhibiting compositions applied between two spheres (e.g. pigs, as referred to in the industry) to coat the fully surface. In embodiments, the batch treatments can be applied with a diluent (e.g. diesel, hydrocarbon, etc.) between about 20-80%, often about 50%, dependent upon operator preference.

In embodiments the batch mono (meth)acrylated and/or bridged imidazoline corrosion inhibitors or the composition can be applied at varying frequencies dependent upon the severity of the operating environment and conditions. In an embodiment, the mono (meth)acrylated and/or bridged imidazoline corrosion inhibitors or the corrosion-inhibiting compositions can be applied weekly, every other week, monthly, or quarterly. The methods described herein beneficially reduce the frequency of batch corrosion inhibitor application as a result of the mono (meth)acrylated and/or bridged imidazoline corrosion inhibitors or the corrosion-inhibiting compositions enhancing the film persistency of the compositions to improve the lifespan of the applied film while also decreasing the frequency of the chemical applications. This reduction in the frequency of chemical applications beneficially reduces costs while also decreasing chemical usage to streamline logistics, reduce chemical handling and any potential associated health and safety risks, reduces the operator's carbon footprint and thereby increasing sustainability of operations. The reduction in the frequency of chemical applications also reduces the need to employ more expensive coatings on infrastructure surfaces.

In embodiments the mono (meth)acrylated and/or bridged imidazoline corrosion inhibitors or the composition is added at a flow rate of a flow line in which the composition is used that can be between 0 and 100 feet per second, or between 0.1 and 50 feet per second. The mono (meth)acrylated and/or bridged imidazoline corrosion inhibitors or the compositions can be formulated with water in order to facilitate addition to the flow line.

In embodiments where the mono (meth)acrylated and/or bridged imidazoline corrosion inhibitors or the composition is added to the fluid system in a batch dosing application, the mono (meth)acrylated and/or bridged imidazoline corrosion inhibitors or the corrosion-inhibiting compositions provide improved corrosion inhibition in a system or on the treated surface as measured by reduced milli-inches per year (mpy). The dosing of the mono (meth)acrylated and/or bridged imidazoline corrosion inhibitors or the corrosion-inhibiting compositions as batch inhibitors allows the chemistry to be applied directly onto the surface and form a film on the surface to act as a barrier to corrosion, including a barrier to the water electrolytes causing corrosion.

### EMBODIMENTS

The present disclosure is further defined by the following numbered embodiments:

1. A corrosion-inhibiting composition comprising: a mono (meth)acrylated (I or II) and/or bridged (III) imidazoline corrosion inhibitor with the following general structures, respectively:

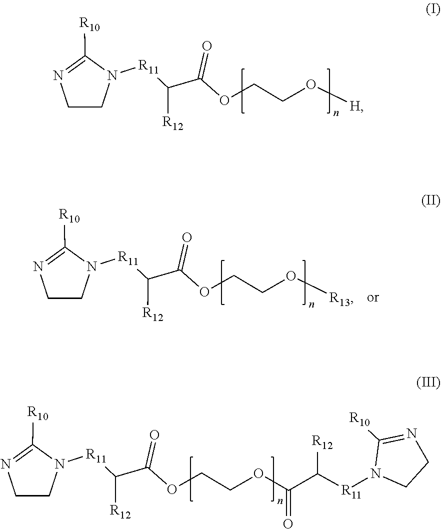

wherein R¹⁰ is a C₁-C₂₀ alkyl, alkenyl, hydroxyalkyl or hydroxyalkenyl group, R¹¹ is a C₁-C₁₀ alkyl amine, R¹² is hydrogen or CH₃, R¹³ is hydrogen, acrylate, methylacrylate, C1-C18 alkyl group, or C1-C6 cycloalkyl group, wherein n is 1 to 22, and wherein the corrosion inhibitor has a molecular weight≥700 Da and, therefore, does not bioaccumulate according to CEFAS regulations.

2. The composition of embodiment 1, wherein the mono (meth)acrylated and/or bridged imidazoline corrosion inhibitor has the following structure, respectively:

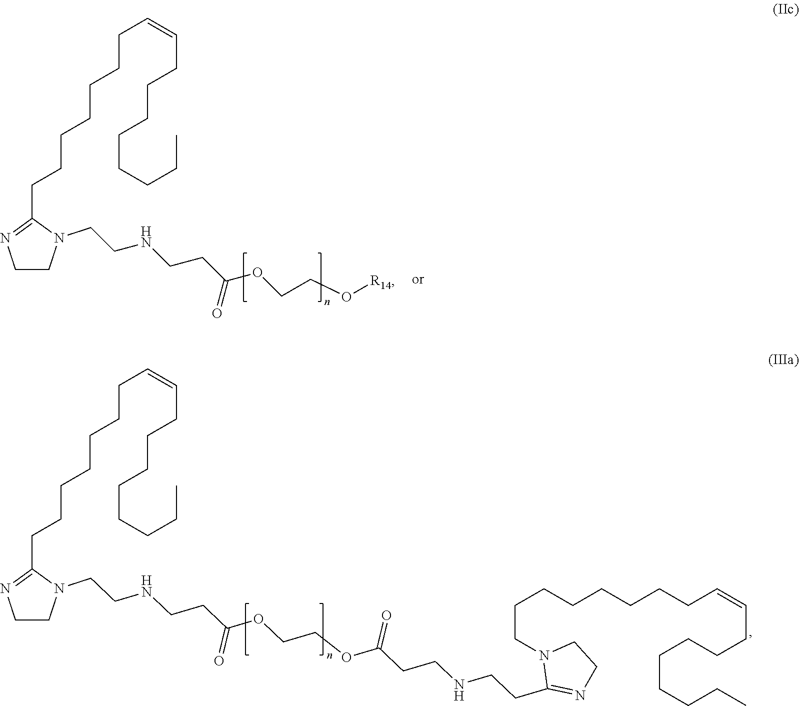

wherein R¹⁴ is hydrogen, C1-C18 alkyl group, or C1-C6 cycloalkyl group, and n is 1 to 22.

3. The composition of any one of embodiments 1-2, wherein the mono (meth)acrylated and/or bridged imidazoline corrosion inhibitor makes up from about 0.1 wt-% to about 90 wt-% of the composition.

4. The composition of any one of embodiments 1-3, further comprising a solvent and/or at least one additional functional ingredient.

5. The composition of embodiment 4, wherein the solvent comprises an organic solvent and/or water and/or wherein the at least one additional functional ingredient is selected from the group consisting of synergist, additional corrosion inhibitors, surfactants, polymers, pH modifiers, scale inhibitors, metal complexing agents, emulsifiers, water clarifiers, dispersants, emulsion breakers and combinations thereof.

6. A method of making a mono (meth)acrylated and/or bridged imidazoline corrosion inhibitor comprising: synthesizing an imidazoline reaction product of a fatty acid, polyamine, and acrylate in a sequential method; wherein the sequential method comprises first reacting the fatty acid and polyamine to produce the imidazoline reaction product, and thereafter reacting the acrylate with the imidazoline reaction product via Michael addition to form the bridged imidazoline corrosion inhibitor having the structure

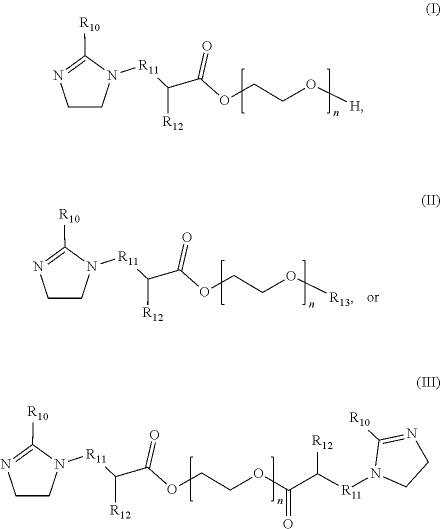

wherein R¹⁰ is a C₁-C₂₀ alkyl, alkenyl, hydroxyalkyl or hydroxyalkenyl group, R¹¹ is a C₁-C₁₀ alkyl amine, R¹² is hydrogen or CH₃, R¹³ is hydrogen, acrylate, methylacrylate, C1-C18 alkyl group, or C1-C6 cycloalkyl group, wherein n is 1 to 22; and wherein the corrosion inhibitor has a molecular weight≥700 Da and, therefore, does not bioaccumulate according to CEFAS regulations.

7. The method of embodiment 6, wherein the sequential method is a single one-pot process and does not separate the imidazoline reaction product before reacting with the acrylate to form the bridged imidazoline corrosion inhibitor.

8. The method of any one of embodiments 6-7, wherein the fatty acid is a tall oil fatty acid (TOFA), or wherein the fatty acid is provided from a fatty oil.

9. The method of embodiment 8, wherein the TOFA fatty acid comprises oleic acid, linoleic acid, abietic acid, neoabietic acid, palustric acid, pimaric acid, dehydroabietic acid, palmitic acid, stearic acid, ricinoleic acid, myristoleic acid, sapienic acid, vaccenic acid, palmitoleic acid, 5,9,12-octadecatrienoic acid, linolenic acid, 5,11,14-eicosatrenoic acid, cis,cis-5,9-octadecadienoic acid, eicosadienoic acid, elaidic acid, cis-11-octadecanoic acid, or a combination thereof.

10. The method of embodiment 8, wherein the fatty oil is castor oil, coconut oil, corn oil, soy bean oil, rapeseed oil, linseed oil, palm oil, safflower oil, peanut oil, canola oil, cotton seed oil, olive oil, sunflower oil, or a combination thereof.

11. The method of any one of embodiments 6-10, wherein the polyamine is diethylene triamine (DETA), aminoethylethanolamine (AEEA), triethylene tetraamine (TETA), tetraethylenepentamine (TEPA), pentaethylene hexamine (PEHA), hexaethylene heptamine (HEHA) or N-alkyl diethylene triamines.

12. The method of any one of embodiments 6-11, wherein the acrylate is a monoacrylate or diacrylate comprising poly(ethylene glycol) diacrylate (PEGDA), tetra ethylene glycol diacrylate (TEGDA), hydroxyl ethyl acrylate, hydroxyethyl acrylate or PEG acrylate.

13. The method of any one of embodiments 6-12, wherein the molar ratio of the amine group on the imidazoline to the carbon double bonds on the acrylate is from about 2:1 to about 1:1, or from about 1.5:1 to about 1:1, or for mono (meth)acrylated imidazoline corrosion inhibitors molar ratio of the amine group on the imidazoline to the carbon double bonds on the acrylate is about 1:1.

14. The method of any one of embodiments 6-13, wherein the reaction temperature is below about 150° F. to prevent side reactions and optionally comprises a solvent.

15. A method of controlling corrosion on a metal surface comprising: contacting a corrosive inhibiting effective amount of the corrosion inhibition composition according to any one of embodiments 1-5, or the mono (meth)acrylated and/or bridged imidazoline corrosion inhibitors produced by the methods of any one of embodiments 6-14, with a metal surface in an oil and-gas system, wherein the contacting is added in a batch or continuous application, and reducing corrosion on the surface.

16. The method of embodiment 15, wherein the corrosive inhibiting effective amount of the mono (meth)acrylated and/or bridged imidazoline corrosion inhibitor or the corrosion inhibition composition is from about 1 ppm to about 5000 ppm, or from about 1 ppm to about 1000 ppm, based on the total volume of the system in contact with the surface.

17. The method of any one of embodiments 15-16, wherein the corrosive inhibiting effective amount of the corrosion inhibition composition or the mono (meth)acrylated and/or bridged imidazoline corrosion inhibitor is added to a water source comprising one or more corrodents to form a treated water source, and wherein the treated water source contacts the metal surface.

18. The method of any one of embodiments 15-17, wherein the system comprises a hydrocarbon fluid or gas, produced water, waste water from a manufacturing process, or combination thereof.

19. A treated metal containment comprising: a metal containment comprising a metal surface; and a barrier or film substantially coating the metal surface with a corrosive inhibiting effective amount of the composition according to any of embodiments 1-5, or the corrosion inhibitor produced by the methods of any one of embodiments 6-14.

20. The treated metal containment of embodiment 19, wherein the corrosive inhibiting effective amount of the mono (meth)acrylated and/or bridged imidazoline corrosion inhibitor or the corrosion inhibition composition is from about 1 ppm to about 5000 ppm, or from about 20 ppm to about 1000 ppm, based on the total volume of the containment.

21. A treated water source comprising: a corrosive inhibiting effective amount of the composition according to any of embodiments 1-5, or the corrosion inhibitor produced by the methods of any one of embodiments 6-14; and a water source comprising one or more corrodents.

22. The treated water source of embodiment 21, wherein the corrosive inhibiting effective amount of the mono (meth)acrylated and/or bridged imidazoline corrosion inhibitor or the corrosion inhibition composition is from about 1 ppm to about 5000 ppm, or from about 20 ppm to about 1000 ppm, based on the total volume of the treated water source.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Synthetization of the Bridged Imidazoline in a Sequential Two-Step Process

First, an imidazoline reaction product intermediate was prepared. 284.4 grams of oleic acid was placed in a glass reactor equipped with mechanical stirrer, condenser, thermocouple and Dean-Stark trap and agitated. 166.0 grams of diethyenetriamine (DETA) was added to the reactor at ambient temperature. The temperature was then set to 260° F., and the reaction mixture was held at 260° F. for 2 hours. After 2 hours, the temperature was increased to 360° F., and the reaction mixture was held at 360° F. for 1 hour. After 1 hour, the temperature was increased to 500° F. and water which was generated during imidazoline formation was removed. The reaction mixture was held at 500° F. under nitrogen for at least 5 hours and then cooled to ambient temperature giving viscous amber material. The reaction was monitored by fourier transform infrared spectroscopy (FTIR) and thin layer chromatography (TLC). The imidazoline intermediate was characterized by mass spectroscopy, electrospray ionization (ESI), high performance liquid chromatography (HPLC), and nuclear magnetic resonance (NMR) to confirm the chemical structure and determine impurities.

Second, a bridged imidazoline corrosion inhibitor was prepared utilizing the imidazoline intermediate of the first step. 80.9 grams of the intermediate imidazoline of the first step and 23.4 grams of monoethylene glycol (MEG) was placed in a flask equipped with mechanical stirrer, condenser, an addition funnel and was agitated at ambient temperature. Then over 30 minutes, 133 grams of polyethylene glycol diacrylate (PEGDA) was added to the flask. After the 30 minutes, when the addition of the PEGDA was completed, the temperature was increased to 140° F. and held for 3-5 hours and then cooled to ambient temperature giving yellow to dark-yellow material. The reaction was monitored by thin layer chromatography and the bridged imidazoline product was characterized by mass spectroscopy and high performance liquid chromatography. The resulting bridged imidazoline corrosion inhibitor structure is shown as the following structure

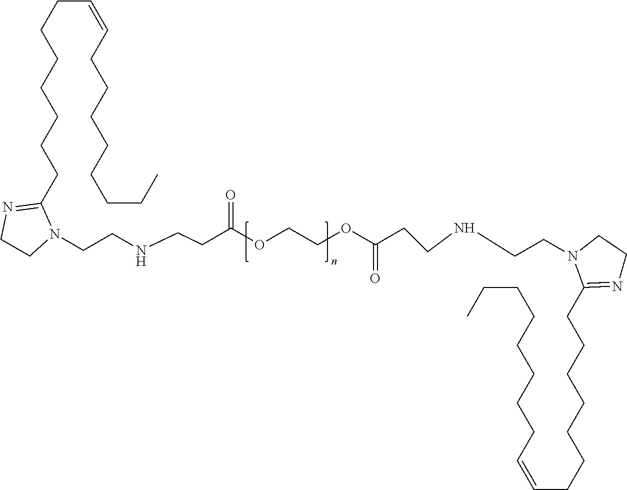

where n is 10-12.

### Example 2

Table 1 summarizes additional examples of synthesized bridged imidazolines using the sequential two-step process as described in Example 1 and the assessment of corrosion inhibition. As shown in Table 1 various batches using fatty acid sources, amines and diacrylates were analyzed. The % corrosion protection (% inhibition) was calculated. The corrosion protection (% Inhibition) is calculated according to the formula:

$$\% Inhibition = 100 \times \frac{Corrosion {Rate}_{No inhibitor} - Corrosion {Rate}_{Inhibitor}}{Corrosion {Rate}_{no inhibitor}}$$

TABLE 1

| Fatty | | | | | |
|---|---|---|---|---|---|
| Acid | | | | Activity, | CI, |
| Source | Amine | Diacrylate | Solvent | % | % |
| TOFA | DETA | NA | No MEG | 100 | 99 |
| TOFA/DETA based imidazoline | | | MEG | 50 | 93 |
| reacted with acrylic acid | | | | | |
| Oleic Acid | DETA | PEGDA (500 Da) | MEG | 70 | >99 |
| Oleic Acid | DETA | PEGDA (500 Da) | MEG | 85 | >99 |
| TOFA | DETA | PEGDA (500 Da) | MEG | 83 | >99 |
| Oleic Acid | DETA | TEGDA | MEG | 87 | >99 |
| Oleic Acid | DETA | TEGDA | MEG | 85 | >99 |
| Castor Oil | DETA | PEGDA (500 Da) | MEG | 90 | NA |

The results show the bridged imidazolines provide effective corrosion inhibition >99%.

### Example 3

Examples were conducted to assess the corrosion inhibitor produced in Example 1 using bubble cell tests to assess corrosion performance using linear polarization resistance testing. The corrosion inhibitor was combined with the sulfur synergist 2-mercaptoethanol.

The bubble test simulates low flow areas where little or no mixing of water and oil occurs. The test was conducted using field brine as shown in Table 2.

TABLE 2

| Salt | Mass (g/L) |
|---|---|
| NaCl | 101.542 |
| CH₃COONa | 26.583 |
| Na₂SO₄ | 0.402 |
| NaHCO₃ | 5.794 |
| KCl | 1.251 |
| CaCl₂•H₂O | 5.399 |

The bubble cell testing was performed according to the conditions in Table 3.

TABLE 3

| | |
|---|---|
| Temperature (° C.) | 65.5 |
| % Water Cut (field brine) | 80 |
| Oil Identifier | LVT |
| Pressure CO₂ (psi) | 14.7 |
| Coupon Type | C-1018 |
| Pre-corrosion | No |
| Pre-partitioning | No |
| Baseline Corrosion Time (hrs.) | 2 |
| Total Test Time (hrs.) | 20 |

The brine was placed into kettles and purged with carbon dioxide resulting in carbon dioxide saturated brine. After the test began, the test cell was blanketed with carbon dioxide one hour prior to electrode insertion and through the duration of the test to maintain saturation. The kettles were stirred at low rpm of approximately 100 revolutions per minute (rpm) for the duration of the test at 65.5° C.

The corrosion rate was measured by Linear Polarization Resistance (LPR) techniques. The working electrode used was carbon steel (C1018 grade). The counter and reference electrodes were both 1018 carbon steel. The electrodes were all cleaned and polished prior to testing. Data was collected for 2 hours to generate a baseline corrosion from about 190-250 mpy) before 5-10 ppm of the corrosion inhibitor composition (containing 20% of the reaction product corrosion inhibitor) was added to the hydrocarbon phase, equating to 2 ppm of the active reaction product corrosion inhibitor with 0.5 ppm 2-mercaptoethanol being introduced into the test cell. Data were collected overnight for an 18 hour test duration. The results are summarized in Table 4.

TABLE 4

| | | | 2- | | Corrosion | |
|---|---|---|---|---|---|---|
| | | | mercaptoethanol | | rate after | |
| CI Dosage | 2- | CI | active | Avg. Blank | 18 hour CI | |
| (active / | mercaptoethanol | Dosage | injected | Corrosion | injection | % |
| ppm) | (%) | (ppm) | (ppm) | Rate (mpy) | (mpy) | Protection |
| 20%/10 ppm | 5% | 2 ppm | 0.5 ppm | 190-250 | <1 | >99% |

The results show the use of bridged imidazoline corrosion inhibitor provides effective corrosion inhibition while also providing the benefits of biodegradability and providing environmentally friendly corrosion inhibitor alternative.

### Example 4

Further corrosion inhibition efficacy was evaluated with a Corrosion Buchi autoclave test performed with the following conditions to evaluate corrosion performance of the bridged imidazoline corrosion inhibitor synthesized in Example 1 under field conditions as described. The test conditions included: 121° C., 100% pre-partitioned synthetic brine as described in Table 2, 16 psi CO₂, 100 psi N₂, 130 Pa shear stress, for 7 days.

The autoclave testing allows for high pressure and high temperature, with or without shear. After the tests, X-65 flat were cleaned for mass loss to calculate general corrosion rate and also scanned using the Bruker Npflex Profilometer to measure pit depth.

The results of the Buchi autoclave testing are shown in Table 5.

TABLE 5

| | Corrosion Rate | Average pit depth |
|---|---|---|
| Corrosion | after 7-day test | after 7-day test |
| Inhibitor | (mpy) | (μm) |
| Imidazoline | 2.42 | 9 |
| Control | | |
| Bridged | 1.82 | 8.9 |
| Imidazoline | | |
| of Example 1 | | |

The results show the evaluated bridged imidazoline corrosion inhibitors provide corrosion inhibition efficacy improved over the control acrylated TOFA-DETA (product of reaction of imidazoline with acrylic acid) for corrosion rate and a slight improvement or substantially the same corrosion pit depth. The Buchi testing further confirms efficacy of the corrosion inhibitors to further supplement the comparative testing of the bubble cell tests.

### Example 5

The corrosion inhibitors were tested using wheel box testing which is a screening method for measuring corrosion inhibition in batch applications. Metal coupons were dip-coated in inhibitor solution at a 1% active chemistry concentration, then placed onto a wheel and immersed in solution. The wheel is rotated in the solution under desired conditions as summarized in Table 6.

TABLE 6

| Conditions | Sweet |
|---|---|
| Steel specimen | C1018 (sandblast finish) |
| Test Brine TDS (mg L−1) | 30,000 |
| Brine:Hydrocarbon ratio | 100% Brine |
| Temperature (° C.) | 60 |
| pCO₂ (psi) | Ambient |
| Brine replenishment | Every 24 h (3 switch-outs) |
| Total test time (h) | 96 |

The testing conditions were run using 1% (active basis) of the corrosion inhibitor produced in Example 1 compared to control acrylated TOFA-DETA (product of reaction of imidazoline with acrylic acid). At regular time intervals, the solution without inhibitor was replenished. At the conclusion of the test, corrosion rates were measured as a function of the mass loss of the metal coupons. The results of the wheel box testing provided % measurement of 49%, representing an improvement over current corrosion inhibitors ranging between about 35-45%. The evaluated corrosion inhibitor products therefore provide not only similar but improved performance while also providing the environmental improvements described herein.

### Example 6

The biodegradability of the corrosion inhibitors were tested according to the Organization for Economic Co-operation and Development (OECD) 306 protocol for seawater closed-bottle biodegradability over 28 days. The test measures biochemical oxygen demand (BOD), which is the total amount of dissolved oxygen used by microbes to metabolize the substance and is based on the calculated theoretical oxygen demand (ThOD).

The toxicity of the substances was also evaluated according to ISO 10253 2006: marine algae growth inhibition test. This is a 72-hour test on skeletonema or phaeodactylum species to measure EC50, the concentration of substance that leads to a 50% reduction in growth.

The results are summarized in Table 7. Biodegradability of active chemistry was based on 85%-wt. formulation in monoethylene glycol (MEG).

TABLE 7

| | 28 day | | | |
|---|---|---|---|---|
| | Biodegradability | | Target | EC50 |
| Sample | Results | By Active | Biodegradability | (Skel., mg/L) |
| Imidazoline | 61% | 19% | >20% | 18.3 |
| Control | | | | |
| Bridged | 37% | 28% | | 10.2 |
| Imidazoline | | | | |
| of Example 1 | | | | |

The results show an EC50 above 10 mg/L for the bridged imidazoline corrosion inhibitor and the imidazoline control which requires the >20% biodegradability of the active corrosion inhibitor due to the molecular weight>700 Da and only the bridged imidazoline corrosion inhibitor meets the biodegradability requirement. In contrast, the imidazoline control meets the toxicity threshold while falling under the CEFAS biodegradability requirement for environmentally friendly corrosion inhibitor compounds.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A corrosion-inhibiting composition comprising:
a bridged imidazoline corrosion inhibitor with the following general structure (III): 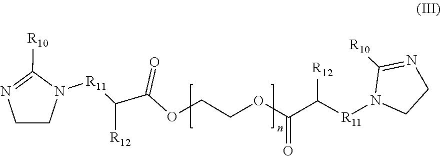
wherein:
R¹⁰ is a C₁-C₂₀ alkyl, alkenyl, hydroxyalkyl or hydroxyalkenyl group,
R¹¹ is a C₁-C₁₀ alkyl amine,
R¹² is hydrogen or CH₃, and
n is 1 to 22, and
wherein the corrosion inhibitor has a molecular weight≥700 Da and, therefore, does not bioaccumulate according to CEFAS regulations, and
a solvent and at least one additional functional ingredient.

2. The composition of claim 1, wherein the bridged imidazoline corrosion inhibitor has the following structure: 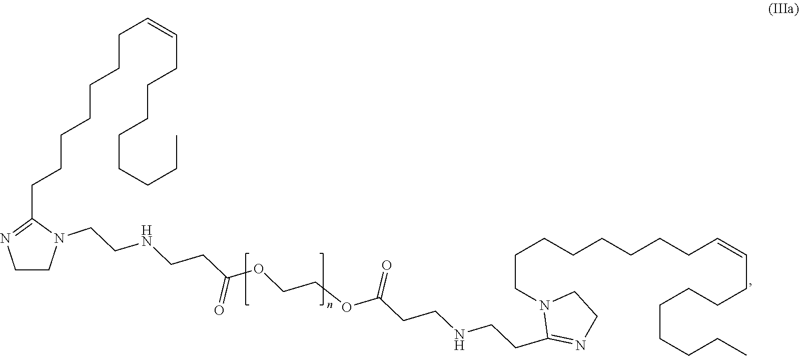
wherein n is 1 to 22.

3. The composition of claim 1, wherein the bridged imidazoline corrosion inhibitor makes up from about 0.1 wt-% to about 90 wt-% of the composition.

4. The composition of claim 1, further comprising a solvent and at least one additional functional ingredient.

5. The composition of claim 4, wherein the solvent comprises an organic solvent and/or water and/or wherein the at least one additional functional ingredient is selected from the group consisting of synergist, additional corrosion inhibitors, surfactants, polymers, pH modifiers, scale inhibitors, metal complexing agents, emulsifiers, water clarifiers, dispersants, emulsion breakers and combinations thereof.

6. A method of making a bridged imidazoline corrosion inhibitor comprising:
synthesizing an imidazoline reaction product of a fatty acid, polyamine, and acrylate in a sequential method;
wherein the sequential method comprises first reacting the fatty acid and polyamine to produce the imidazoline reaction product, and thereafter reacting the acrylate with the imidazoline reaction product via Michael addition to form the bridged imidazoline corrosion inhibitor having the structure 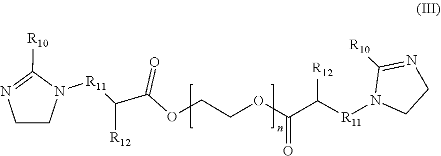
wherein R¹⁰ is a C₁-C₂₀ alkyl, alkenyl, hydroxyalkyl or hydroxyalkenyl group, R¹¹ is a C₁-C₁₀ alkyl amine, R¹² is hydrogen or CH₃, and n is 1 to 22; and wherein the corrosion inhibitor has a molecular weight≥700 Da and, therefore does not bioaccumulate according to CEFAS regulations.

7. The method of claim 6, wherein the sequential method is a single one-pot process and does not separate the imidazoline reaction product before reacting with the acrylate to form the bridged imidazoline corrosion inhibitor.

8. The method of claim 6, wherein the fatty acid is a tall oil fatty acid (TOFA) or is provided from a fatty oil.

9. The method of claim 8, wherein the TOFA fatty acid comprises oleic acid, linoleic acid, abietic acid, neoabietic acid, palustric acid, pimaric acid, dehydroabietic acid, palmitic acid, stearic acid, ricinoleic acid, myristoleic acid, sapienic acid, vaccenic acid, palmitoleic acid, 5,9,12-octadecatrienoic acid, linolenic acid, 5,11,14-eicosatrenoic acid, cis,cis-5,9-octadecadienoic acid, eicosadienoic acid, elaidic acid, cis-11-octadecanoic acid, or a combination thereof, or wherein the fatty oil is castor oil, coconut oil, corn oil, soy bean oil, rapeseed oil, linseed oil, palm oil, safflower oil, peanut oil, canola oil, cotton seed oil, olive oil, sunflower oil, or a combination thereof.

10. The method of claim 6, wherein the polyamine is diethylene triamine (DETA), aminoethylethanolamine (AEEA), triethylene tetraamine (TETA), tetraethylenepentamine (TEPA), pentaethylene hexamine (PEHA), hexaethylene heptamine (HEHA) or N-alkyl diethylene triamines.

11. The method of claim 6, wherein the acrylate is a monoacrylate or diacrylate comprising poly(ethylene glycol) diacrylate (PEGDA), tetra ethylene glycol diacrylate (TEGDA), hydroxyl ethyl acrylate, hydroxyethyl acrylate or PEG acrylate.

12. The method of claim 6, wherein the molar ratio of the amine group on the imidazoline to the carbon double bonds on the acrylate is from about 2:1 to about 1:1, or from about 1.5:1 to about 1:1.

13. The method of claim 6, wherein the reaction temperature is below about 150° F. to prevent side reactions and optionally comprises a solvent.

14. A method of controlling corrosion on a metal surface comprising:
contacting a corrosive inhibiting effective amount of the corrosion inhibition composition of claim 1 with a metal surface in an oil-and-gas system, wherein the system comprises a hydrocarbon fluid or gas, produced water, waste water from a manufacturing process, or combination thereof, and
wherein the contacting is added in a batch or continuous application, and reducing corrosion on the surface.

15. The method of claim 14, wherein the corrosive inhibiting effective amount of the bridged imidazoline corrosion inhibitor composition is from about 1 ppm to about 5000 ppm, based on the total volume of the system in contact with the surface.

16. The method of claim 14, wherein the corrosive inhibiting effective amount of the corrosion inhibition composition is added to a water source comprising one or more corrodents to form a treated water source, and wherein the treated water source contacts the metal surface.

17. A treated metal containment comprising:
a metal containment comprising a metal surface; and
a barrier or film substantially coating the metal surface with a corrosive inhibiting effective amount of the corrosion inhibitor composition of claim 1.

18. The treated metal containment of claim 17, wherein the corrosive inhibiting effective amount of the corrosion inhibition composition is from about 1 ppm to about 5000 ppm, or from about 20 ppm to about 1000 ppm, based on the total volume of the containment.

19. A treated water source comprising:
a corrosive inhibiting effective amount of the composition according to claim 1; and
a water source comprising one or more corrodents.

20. The treated water source of claim 19, wherein the corrosive inhibiting effective amount of the corrosion inhibition composition is from about 1 ppm to about 5000 ppm, or from about 20 ppm to about 1000 ppm, based on the total volume of the treated water source.
